(19) United States
(12) Patent Application Publication
(10) Pub. No.: US 2022/0381574 A1
(43) Pub. Date: Dec. 1, 2022

(54) MULTIPATH GENERATION METHOD, APPARATUS, DEVICE AND STORAGE MEDIUM

(71) Applicant: BEIJING BAIDU NETCOM SCIENCE TECHNOLOGY CO., LTD., Beijing (CN)

(72) Inventors: Linpei ZHANG, Beijing (CN); Li ZHAI, Beijing (CN)

(73) Assignee: BEIJING BAIDU NETCOM SCIENCE TECHNOLOGY CO., LTD., Beijing (CN)

(21) Appl. No.: 17/818,375

(22) Filed: Aug. 9, 2022

(30) Foreign Application Priority Data
Mar. 16, 2022 (CN) 2022102600071

(51) Int. Cl. G01C 21/34

(52) U.S. Cl. CPC G01C 21/3492

(57) ABSTRACT

Embodiments of the present disclosure provide a multipath generation method, an apparatus, a device and a storage medium, and relate to the field of artificial intelligence, in particular to the field of intelligent transportation. A specific implementation solution is: in response to a path generation request, generating M recommended paths from a starting node to a destination node, where the M recommended paths are generated through m path generation processes including: in an i-th path generation process, generating nᵢ recommended paths based on a constructed search tree, and for each recommended path of the nᵢ recommended paths, determining traffic costs of road segments of the recommended path in an (i+1)-th path generation process according to penalty factors, the traffic costs being associated with a recommendation priority of path; where m≥i≥1, M>nᵢ>1.

### CROSS-REFERENCE TO RELATED APPLICATIONS

This application claims priority to Chinese Patent Application No. 2022102600071 filed on Mar. 16, 2022, which is hereby incorporated by reference in its entirety.

### TECHNICAL FIELD

The present disclosure relates to the field of intelligent transportation in artificial intelligence and, in particular, to a multipath generation method, an apparatus, a device and a storage medium.

### BACKGROUND

Continuous optimization of the traffic network provides a wealth of selectable paths for users to travel by car. When a user has a travel need, a path generation system based on artificial intelligence can generate selectable paths from a starting point to an ending point according to the starting point and the ending point set by the user.

At present, the path generation system often generates multiple paths through multiple iterations based on a penalty model. The penalty model generates a path from a starting point to an ending point in one iteration process, penalizes the generated path, that is, changes weights of road segments of the path, and then performs the next iteration process, so that another path from the starting point to the ending point is generated in the next iteration process. However, when the path generation is realized based on the penalty model, it takes a long time to generate multiple paths, and repetitiveness of the paths generated by multiple iterations is high, resulting in poor path diversity.

### SUMMARY

Embodiments of the present disclosure provide a multipath generation method, an apparatus, a device and a storage medium.

According to a first aspect of the present disclosure, a multipath generation method is provided, including: in response to a path generation request, generating M recommended paths from a starting node to a destination node, the starting node being a node that a path starting point in the path generation request is mapped to in a traffic topology network and the destination node being a node that a path ending point in the path generation request is mapped to in the traffic topology network; where the M recommended paths are generated through m generation processes including: in an i-th path generation process, generating nᵢ recommended paths based on a constructed search tree, and for each recommended path of the nᵢ recommended paths, determining traffic costs of road segments of the recommended path in an (i+1)-th path generation process according to penalty factors, the traffic costs being associated with a recommendation priority of path; where m≥i≥1, M>nᵢ>1.

According to the second aspect of the present disclosure, an electronic device is provided, including: at least one processor; and a memory communicatively connected with the at least one processor; where the memory stores instructions executable by the at least one processor, and the instructions are executed by the at least one processor to enable the at least one processor to: in response to a path generation request, generate M recommended paths from a starting node to a destination node, the starting node being a node that a path starting point in the path generation request is mapped to in a traffic topology network and the destination node being a node that a path ending point in the path generation request is mapped to in the traffic topology network; where the M recommended paths are generated through m generation processes including: in an i-th path generation process, generating nᵢ recommended paths based on a constructed search tree, and for each recommended path of the nᵢ recommended paths, determining traffic costs of road segments of the recommended path in an (i+1)-th path generation process according to penalty factors, the traffic cost being associated with a recommendation priority of path; where m≥i≥1, M>nᵢ>1.

According to a third aspect of the present disclosure, a non-transitory computer-readable storage medium having computer instructions stored thereon is provided, where the computer instructions are used to cause a computer to execute the following steps: in response to a path generation request, generate M recommended paths from a starting node to a destination node, the starting node being a node that a path starting point in the path generation request is mapped to in a traffic topology network and the destination node being a node that a path ending point in the path generation request is mapped to in the traffic topology network; where the M recommended paths are generated through m generation processes including: in an i-th path generation process, generating nᵢ recommended paths based on a constructed search tree, and for each recommended path of the nᵢ recommended paths, determining traffic costs of road segments of the recommended path in an (i+1)-th path generation process according to penalty factors, the traffic cost being associated with a recommendation priority of path; where m≥i≥1, M>nᵢ>1.

It should be understood that the content described in this section is neither intended to identify key or important features of embodiments of the present disclosure, nor to limit the scope of the present disclosure. Other features of the present disclosure will become easy to understand through the following description.

### BRIEF DESCRIPTION OF DRAWINGS

Drawings are used to better understand the solutions, and do not constitute a limitation to the present disclosure. Among them:

FIG. 1 is a schematic structural diagram of a path generation system 100 according to an embodiment of the present disclosure.

FIG. 2 is a schematic flowchart of a multipath generation method 200 according to an embodiment of the present disclosure.

FIG. 3 is a schematic structural diagram of a search tree according to an embodiment of the present disclosure.

FIG. 4 is a schematic flowchart of another multipath generation method 300 according to an embodiment of the present disclosure.

FIG. 5 is a schematic block diagram of a multipath generation apparatus 400 according to an embodiment of the present disclosure.

FIG. 6 is a schematic block diagram of another multipath generation apparatus according to an embodiment of the present disclosure.

FIG. 7 shows a schematic block diagram of an example electronic device 500 that can be used to implement embodiments of the present disclosure.

### DESCRIPTION OF EMBODIMENTS

Exemplary embodiments of the present disclosure are illustrated below in conjunction with the drawings, where various details of the embodiments of the present disclosure are included to facilitate understanding, and they should be regarded as merely exemplary. Therefore, those of ordinary skill in the art should realize that various changes and modifications may be made to the embodiments described herein without departing from the scope and the spirit of the present disclosure. Likewise, for clarity and conciseness, descriptions of well-known functions and structures are omitted in the following description.

The multipath generation method provided by embodiments of the present disclosure can be applied to any field that needs path generation, in particular to the fields of intelligent transportation, deep learning, big data and Internet of Vehicles.

An executive entity of the present disclosure may be an electronic device, and all the methods related to path generation mentioned in the present disclosure can be executed by the electronic device or functional modules deployed therein. The electronic device can be any terminal device, such as a navigation device, a mobile phone, a computer, a tablet, a smart wearable, etc. Or, the electronic device may be an intelligent vehicle, which may be a vehicle with an automatic driving function. The intelligent vehicle provided by the embodiments of the present disclosure may utilize various sensors, map databases, Global Positioning System (Global Positioning System, GPS), etc., to realize automatic driving of the vehicle. The present disclosure does not limit the shape of the intelligent vehicle, that is, any movable device with an automatic driving function also belongs to the protection scope of the present disclosure.

The above electronic device may also be a server. By executing the multipath generation method provided by the present disclosure by the server, it is more convenient to obtain traffic topology network data required for the path generation, and better computing power can be provided for the path generation. In the present disclosure, the server can interact with the above terminal device or intelligent vehicle. For example, the server acquires a path generation request inputted by a user through the terminal device or the intelligent vehicle, and performs path generation according to the path generation request. For another example, the server pushes generated recommended paths to the terminal device or the intelligent vehicle to display the recommended paths to the user through the terminal device or the intelligent vehicle.

The server may be implemented, for example, as a server or a server cluster. In some embodiments, the server may be implemented as a cloud server or a cloud server cluster, and at least one of a cloud storage server and a cloud computing server may be deployed in the cloud server cluster.

The cloud computing server is used to provide cloud computing services. Cloud computing (cloud computing), as a computing mode, is to distribute computing tasks on a resource pool consisting of a large number of computers, so that various application systems can obtain computing power, storage space and information services as needed.

The cloud storage server is used to provide cloud storage services. Cloud storage (cloud storage) is a storage system that extends and develops from the concept of cloud computing, and that integrates a large number of different types of storage devices (storage devices are also called storage nodes) in a network through application software or application interfaces to work cooperatively to jointly provide data storage and service access functions to the outside.

Aiming at the problems of low path generation efficiency and poor diversity of generated paths, embodiments of the present disclosure provide a multipath generation method, which introduces a search tree for path search, generates a plurality of recommended paths based on the constructed search tree in each path generation process, and obtains a plurality of recommended paths by iteratively executing the path generation process, thereby enriching the diversity of paths and improving the path generation efficiency.

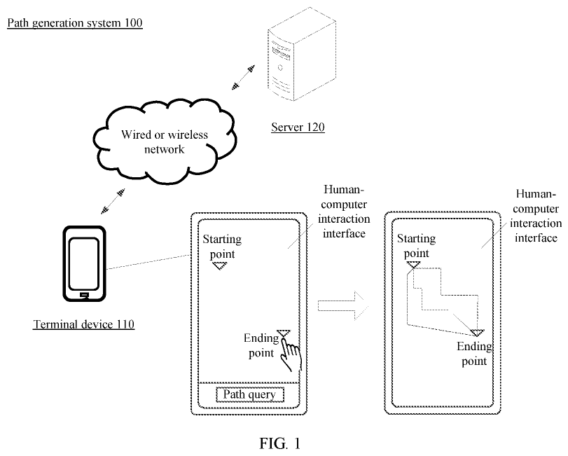

FIG. 1 is a schematic structural diagram of a path generation system 100 according to an embodiment of the present disclosure. The method provided by the embodiments of the present disclosure can be applied to a path generation system 100 shown in FIG. 1. The system 100 may include a terminal device 110 and a server 120 as described above, and the terminal device 110 and the server 120 are connected in a wired or wireless manner.

The terminal device 110 is deployed with a human-computer interaction module 111. The terminal device 110 receives a path generation request inputted by a user through the human-computer interaction module 111, and the terminal device 110 can also display recommended paths to the user through the human-computer interaction module 111.

The server 120 receives the path generation request sent by the terminal device 110, generates the recommended paths according to the path generation request, and then sends the recommended paths to the terminal device 110.

It should be noted that the path generation system 100 in FIG. 1 may not include the server 120, and when the path generation system does not include the server 120, the terminal device 110 executes the above process performed by the server 120.

The technical solutions in the present disclosure will be described in detail below with specific embodiments.

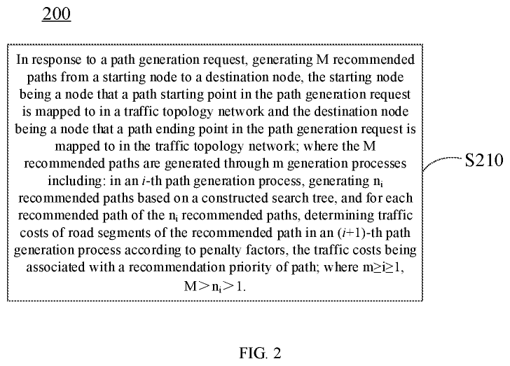

FIG. 2 is a schematic flowchart of a multipath generation method 200 according to an embodiment of the present disclosure. An executive entity of the embodiment of the present disclosure may be the electronic device in the above embodiment, for example, the server 120 in FIG. 1. As shown in FIG. 2, the method 200 includes:

S210, in response to a path generation request, generating M recommended paths from a starting node to a destination node, the starting node being a node that a path starting point in the path generation request is mapped to in a traffic topology network, and the destination node being a node that a path ending point in the path generation request is mapped to in the traffic topology network.

The traffic topology network in the embodiment of the present disclosure is an abstract representation of a traffic network. The traffic topology network is obtained by mapping according to the positional relationship of road segments and intersections in the traffic network without considering the shape and size. For example, the intersections in the traffic network may be mapped to nodes, and the road segments in the traffic network may be mapped to edges between the nodes. Certainly, some special positions in the traffic network may also be mapped to nodes, for example, a starting point for path planning as required is mapped to a starting node, an ending point for path planning as required is mapped to a destination node.

It should be noted that the path generation request may be a request that a user inputs and the electronic device receives. For example, the user inputs the path generation request by inputting the starting point and the ending point in the human-computer interaction interface and selecting a path query control. Or, the path generation request may be a request that other devices input and the electronic device receives. For example, the server 120 in FIG. 1 receives the path generation request sent by the terminal device 110. Certainly, the terminal device 110 can acquire the path generation request based on the user's input or receive the path generation request sent by other devices, which is not limited in the present disclosure.

For the above S210, it should be noted that the M recommended paths are generated through m path generation processes. The following takes an i-th path generation process as an example to illustrate the iterative generation processes of the M recommended paths. It should be understood that the i-th path generation process is any one of the m path generation processes.

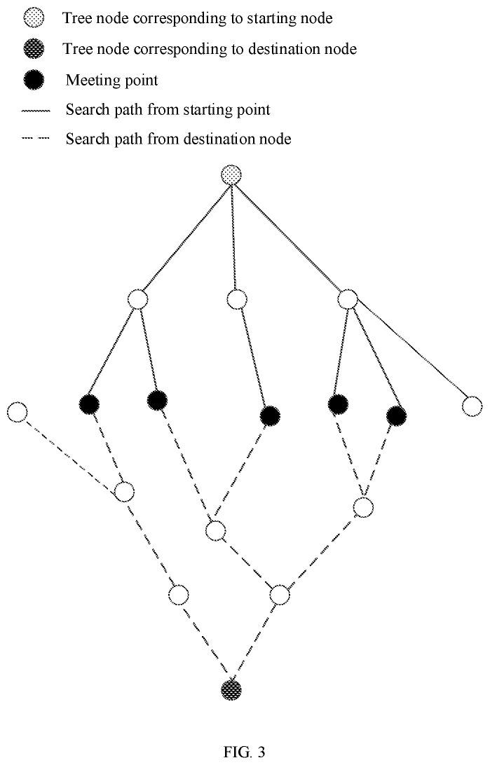

In the i-th path generation process, nᵢ recommended paths are generated based on a constructed search tree. In the path generation process, any tree node of the search tree corresponds to a node in the traffic topology network. As shown in FIG. 3, tree nodes at both ends of the search tree correspond to the starting node and the destination node of the traffic topology network respectively, and tree nodes of the search tree other than the tree nodes at both ends correspond to nodes between the starting node and the destination node in the traffic topology network respectively. The electronic device can generate nᵢ recommended paths in one path generation process based on the search tree. Compared with generating one recommended path each time in the prior art, the present disclosure improves the efficiency of path generation.

Following the above example, in the i-th path generation process, for each recommended path in the nᵢ recommended paths, traffic costs of road segments of the recommended path in an (i+1)-th path generation process are determined according to penalty factors, so that the electronic device can generate nᵢ₊₁ recommended paths in the (i+1)-th path generation process according to the traffic costs. It should be noted that a traffic cost is used to represent traffic time, toll cost, traffic difficulty and the like of the corresponding road segment, and the traffic cost may be expressed as the weight of the road segment. A traffic cost of the recommended path may be determined according to the traffic costs of the road segments of the recommended path. Therefore, the traffic costs of the road segments may be used to determine a traffic cost of a recommended path generated in the next path generation process, that is, the traffic costs are associated with a recommendation priority of the path.

Based on the above iteration processes, the electronic device can generate M recommended paths in m path generation processes. The M recommended paths may be a sum of the recommended paths generated by the m path generation processes, for example,

$$M = {\sum }_{1}^{m} {n}_{i}$$

or, the M recommended paths may be determined based on

$${\sum }_{1}^{m} {n}_{i}$$

recommended paths, which is not limited in the present disclosure.

In the embodiment of the present disclosure: m≥i≥1, M>nᵢ>1. In general, a plurality of meeting points can be obtained by constructing the search tree, that is, more than one recommended path can be generated in one path generation process, so M>m Certainly, the present disclosure does not exclude the case of M=m or M<m.

In some embodiments, the electronic device may push the M recommended paths to the user, for example, display the M recommended paths through a display screen of the terminal device; or the electronic device may push the M recommended paths to other devices, for example, the server 120 in FIG. 1 pushes the M recommended paths (the path marked by a solid line or a dotted line between the starting point and the ending point as shown in FIG. 1) to the terminal device 110. Of course, the terminal device 110 may display the M recommended paths to the user through the display screen, which is not limited in the present disclosure.

The multipath generation method provided by the embodiments of the present disclosure is applied to the fields of intelligent transportation, deep learning, big data, and Internet of Vehicles in the field of artificial intelligence, so as to improve the diversity of recommended paths and the efficiency of path generation.

In the embodiments of the present disclosure, determining the traffic cost of the road segment according to the penalty factor may be simply expressed as: punishing the road segment according to the penalty factor. The contents expressed by the two are consistent, and the two can be used alternately.

In some embodiments, the recommended paths of the above M recommended paths may correspond to a set of penalty factors, and the set of penalty factors corresponding to the recommended paths may be the same or different, which is not limited in the present disclosure.

In some embodiments, among the plurality of road segments included in the above recommended path, the penalty factor corresponding to each road segment may be different. In the above i-th path generation process, determining the traffic costs of the road segments of the recommended path in the (i+1)-th path generation process according to the penalty factors may be specifically implemented as: determining, according to a penalty factor corresponding to each road segment of a plurality of road segments of each recommended path, the traffic cost of the corresponding segment in the (i+1)-th path generation process, so as to realize a fine-grained penalty for each road segment.

The penalty factor may be positively correlated with the traffic cost of the road segment. For example, the greater the value of the penalty factor, the greater the traffic cost obtained by penalty.

Further, in one recommended path, the penalty factor corresponding to each road segment may be determined according to a position of the road segment in the recommended path. For example, a value of a corresponding penalty factor is larger for a road section close to an edge of the recommended path (such as incoming-edge of the path and/or outgoing-edge of the path), and a value of a corresponding penalty factor is smaller for a road segment farther away from the edge of the recommended path. In this case, in the (i+1)-th path generation process, the possibility of selecting an edge road segment is low, thereby making a difference between the recommended path generated in the (i+1)-th path generation process and the recommended path generated in the i-th path generation process greater, which is conducive to enriching the diversity of recommended paths.

In some embodiments, in the i-th path generation process, the electronic device can construct a search tree from the starting node to the destination node. As shown in FIG. 3, the search tree includes Nᵢ meeting points, Nᵢ≥nᵢ. The Nᵢ meeting points are path nodes on Nᵢ paths between the starting node and the destination node respectively, and a path node is a node travelled through by a path formed between the starting node and the destination node.

At present, the construction of a search tree by an electronic device is usually implemented based on a dual-process unidirectional search. For example, the electronic device starts to search from a starting node to a destination node in one search process and starts to search from the destination node to the starting node in another search process, and then obtains a path according to a meeting point formed by the two search processes. However, the electronic device needs to complete the path searches between the starting node and the destination node in both search processes, and the search space is large, resulting in low search efficiency.

In the embodiment of the present disclosure, the construction of the search tree from the starting node to the destination node by the electronic device is implemented based on a single-process bidirectional search. It should be noted that the single-process bidirectional search is a possible naming, which is not limited in the present disclosure. Adopted technologies similar to the present disclosure but using other naming methods also belong to the scope of protection of the present disclosure. For example, as shown in FIG. 3, in one search process, the electronic device starts from the starting node and the destination node, respectively, to search, and ends the search process when Nᵢ meeting points of the search process are formed, that is, the construction process of the search tree is completed. Thick lines in FIG. 3 identify Nᵢ paths.

The present disclosure only takes a single process as an example for description, which should not be construed as any limitation to the present disclosure. For example, the electronic device may also search through two search processes. One search process starts from the starting node, and the other search process starts from the destination node. When Nᵢ meeting points of the search tree are formed, the two search processes are ended, that is, the construction process of the search tree is completed.

Following the above embodiment, in the i-th path generation process, after the electronic device constructs the search tree from the starting node to the destination node, the electronic device can determine nᵢ recommended paths according to traffic costs respectively corresponding to the Nᵢ paths. Exemplary, for each path of the Nᵢ paths, the electronic device can sum traffic costs respectively corresponding to a plurality of road segments of the path to obtain a traffic cost of the path, sort the Nᵢ paths in ascending order of the traffic costs, and determine first nᵢ paths as the nᵢ recommended paths.

In some embodiments, the electronic device can end the iteration processes in response to a first trigger event. The first trigger event includes, but is not limited to, at least one of the following:

i is greater than or equal to a preset quantity of iterations; execution time is greater than or equal to preset iteration time, where a start time of the execution time is a start time of a first path generation process, and an end time of the execution time is an end time of the i-th path generation process; a sum of quantities of recommended paths generated by first i path generation processes is greater than or equal to a preset quantity of paths. For example, if it is determined that i is greater than or equal to the preset quantity of iterations, the electronic device stops executing the (i+1)-th path generation process.

As an example, the processing procedure in any of the above embodiments may be implemented based on a waypoint model and a penalty model. For example, in the i-th path generation process, the construction of the search tree and the generation of the nᵢ recommended paths may be implemented by the waypoint model, which is obtained by training based on a first network model. The determining of the traffic cost of each road segment of each recommended path of the nᵢ recommended paths in the (i+1)-th path generation process according to the penalty factor may be implemented by the penalty model, which is obtained by training based on a second network model.

As another example, the processing procedure in any of the above embodiments may be implemented based on a path generation model, and the path generation model may obtain the M recommended paths based on the inputted starting node and destination node. The path generation model may be obtained by training based on a third network model.

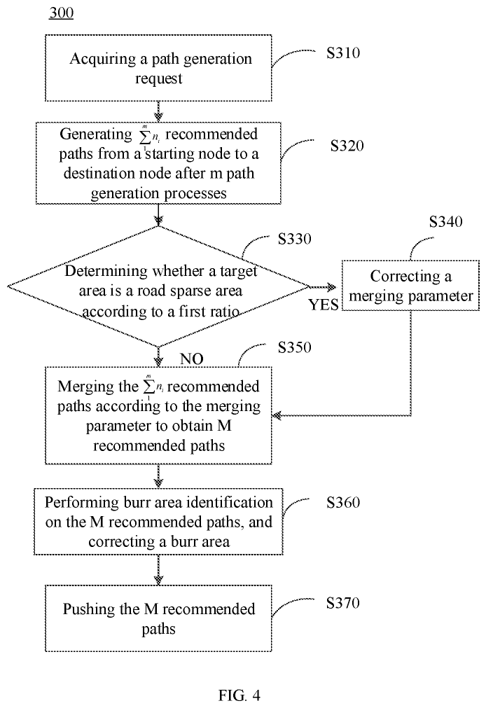

FIG. 4 is a schematic flowchart of another multipath generation method 300 according to an embodiment of the present disclosure. As shown in FIG. 4, the method 300 includes part or all of processes in the following S310 to S340.

S310, acquiring a path generation request.

S320, generating

$${\sum }_{1}^{m} {n}_{i}$$

recommended paths from a starting node to a destination node after m path generation processes.

S330, determining whether a target area is a road sparse area according to a first ratio, where the target area includes the starting node and the destination node, and the first ratio is a ratio of a quantity of valid path generation processes to m.

When the target area is the road sparse area, the following S340 and S350 are performed in sequence. When the target area is not the road sparse area, the following S350 is performed.

S340, correcting a merging parameter.

S350, merging the

$${\sum }_{1}^{m} {n}_{i}$$

recommended paths according to the merging parameter to obtain M recommended paths.

S360, performing burr area identification on the M recommended paths, and correcting a burr area.

S370, pushing the M recommended paths.

S310, S320 and S370 have the same or similar implementations and technical effects as those of the corresponding processes in the embodiment shown in FIG. 2, which will not be repeated here.

In the above S330, the target area may be an area where a path search is performed. For each path generation process in the above m path generation processes, whether it is a valid path generation process is determined. Taking the i-th path generation process as an example, if a recommended path with the highest recommendation priority among the nᵢ recommended paths is not a recommended path generated in first i−1 recommended path generation processes, in other words, the recommended path with the highest recommended priority among the nᵢ recommended paths is not generated in the first i−1 recommended path generation process, the i-th path generation process is determined as a valid path generation process; if the recommended path with the highest recommended priority among the nᵢ recommended paths is a recommended path that has been generated in the first i−1 recommended path generation processes, the i-th path generation process is determined as an invalid path generation process. Based on this, the electronic device can use the ratio of the quantity of valid path generation processes in the m path generation processes to m as the first ratio to determine that there are fewer paths in the target area (that is, the target area is the sparse road area) when the first ratio is greater than or equal to a preset ratio (e.g., 30%, 40%, 50%, etc.). On the contrary, the electronic device can determine that there are more paths in the target area (that is, the target area is not the road sparse area) when the first ratio is less than the preset ratio.

Further, when the target area is the road sparse area, compared with a road non-sparse area, it is necessary to merge the iteratively generated recommended paths as little as possible to enrich the diversity of recommended paths. Based on this, in the above S340, the electronic device needs to correct the merging parameter when the target area is the road sparse area, so that more recommended paths can be reserved when the paths are merged based on the corrected merging parameter.

For the above S360, it should be noted that there may be a burr area (or called badcase) in any recommended path. For example, there are two sampling points whose timing is less than preset time in the recommended path, and the two sampling points are located at the same node in the traffic topology network, which indicates that there may be abnormal road segments such as detours and congestion in the recommended path. The area consisting of these abnormal road segments is the burr area. Correcting of these burr areas makes the recommended paths more reasonable.

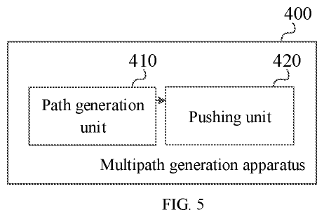

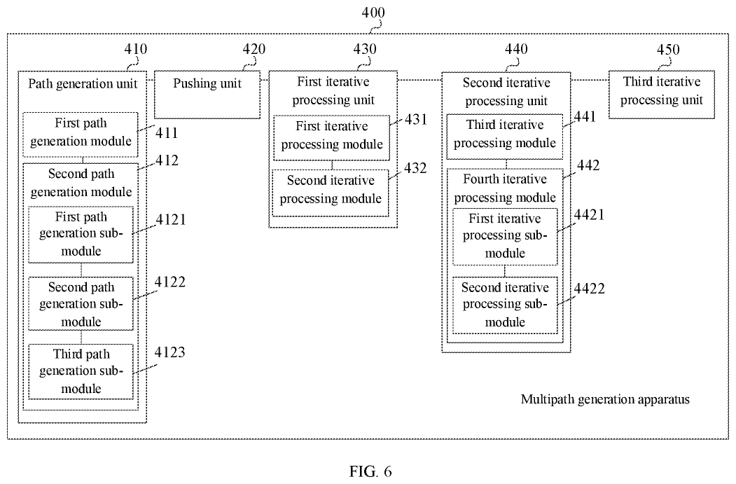

The method embodiments of the present disclosure are described in detail with reference to FIG. 2 to FIG. 4 above, and apparatus embodiments of the present disclosure are described in detail with reference to FIG. 5 to FIG. 6 below. It should be understood that the apparatus embodiments correspond to the method embodiments, and the method embodiments can be referred to for similar descriptions.

FIG. 5 is a schematic block diagram of a multipath generation apparatus 400 according to an embodiment of the present disclosure. As shown in FIG. 5, the multipath generation apparatus 400 includes:

a path generation unit 410, configured to, in response to a path generation request, generate M recommended paths from a starting node to a destination node, the starting node being a node that a path starting point in the path generation request is mapped to in a traffic topology network, and the destination node being a node that a path ending point in the path generation request is mapped to in the traffic topology network;

where the M recommended paths are generated through m path generation processes including: in an i-th path generation process, generating nᵢ recommended paths based on a constructed search tree, and for each recommended path of the nᵢ recommended paths, determining traffic costs of road segments of the recommended path in an (i+1)-th path generation process according to penalty factors, the traffic costs being associated with a recommendation priority of path; where m≥i≥1, M>nᵢ>1.

In some embodiments, the apparatus 400 further includes a pushing unit 420, configured to push the M recommended paths.

On the basis of the embodiment shown in FIG. 5, FIG. 6 is a schematic block diagram of another multipath generation apparatus according to an embodiment of the present disclosure. The apparatus 400 will be described below with reference to FIG. 6.

In some embodiments, the apparatus 400 further includes a first iterative processing unit 430, where the first iterative processing unit 430 includes a first iterative processing module 431; the first iterative processing module 431 is configured to determine, according to a penalty factor corresponding to each road segment of a plurality of road segments, a traffic cost of the road segment in the (i+1)-th path generation process.

In some embodiments, the first iterative processing unit 430 further includes a second iterative processing module 432; the second iterative processing module 432 is configured to determine the penalty factors respectively corresponding to the plurality of road segments of the recommended path according to positions of the plurality of road segments of the recommended path in the recommended path.

In some embodiments, the apparatus 400 includes a second iterative processing unit 440, where the second iterative processing unit 440 includes a third iterative processing module 441 and a fourth iterative processing module 442. The third iterative processing module 441 is configured to construct a search tree from the starting node to the destination node, where the search tree includes Nᵢ meeting points, Nᵢ≥nᵢ, and the Nᵢ meeting points are path nodes on Nᵢ paths from the starting node to the destination node respectively. The fourth iterative processing module 442 is configured to determine the nᵢ recommended paths according to traffic costs respectively corresponding to the Nᵢ paths.

In some embodiments, the third iterative processing module 441 is specifically configured to: construct the search tree by starting from the starting node and the destination node respectively, and end a search tree constructing process when the Nᵢ meeting points of the search tree are formed.

In some embodiments, the fourth iterative processing module 442 includes a first iterative processing submodule 4421 and a second iterative processing submodule 4422. The first iterative processing submodule 4421 is configured to, for each path of the Nᵢ paths, sum traffic costs respectively corresponding to the plurality of road segments of the path, to obtain a traffic cost of the path. The second iterative processing sub-module 4422 is configured to sort the Nᵢ paths in ascending order of the traffic costs, and determine first nᵢ paths as the nᵢ recommended paths.

In some embodiments, the apparatus 400 further includes: a third iterative processing unit 450, configured to, in response to a first trigger event, stop executing the (i+1)-th path generation process; where the first trigger event includes at least one of the following:

i is greater than or equal to a preset quantity of iterations;

execution time is greater than or equal to preset iteration time, where a start time of the execution time is a start time of a first path generation process, and an end time of the execution time is an end time of the i-th path generation process;

a sum of quantities of recommended paths generated by first i path generation processes is greater than or equal to a preset quantity of paths.

In some embodiments, the path generation unit 410 includes a first path generation module 411. The first path generation module 411 is configured to merge

$${\sum }_{1}^{m} {n}_{i}$$

recommended paths generated in the m path generation processes according to a merging parameter, to obtain the M recommended paths.

In some embodiments, the path generation unit 410 further includes a second path generation module 412, where the second path generation module 412 includes a first path generation sub-module 4121 and a second path generation sub-module 4122. The first path generation sub-module 4122 is configured to determine whether a target area is a road sparse area according to a first ratio, where the target area includes the starting node and the destination node, and the first ratio is a ratio of a quantity of valid path generation processes to m. The second path generation sub-module 4122 is configured to correct the merging parameter when the target area is the road sparse area.

In some embodiments, the second path generation module 412 includes a third path generation sub-module 4123. The third path generation sub-module 4123 is configured to, if a recommended path with the highest recommended priority among the nᵢ recommended paths is not a recommended path generated in first i−1 recommended path generation processes, determine the i-th path generation process as a valid path generation process.

In some embodiments, the path generation unit 410 further includes a third path generation module 413. The third path generation module 413 is configured to perform burr area identification on the M recommended paths, and correct a burr area.

The apparatuses provided in the above embodiments of FIG. 5 and FIG. 6 can implement the technical solutions on the intelligent vehicle side of the above method embodiments, and the implementation principles and technical effects thereof are similar and will not be repeated here.

According to embodiments of the present disclosure, the present disclosure also provides an electronic device, a readable storage medium and a computer program product.

According to an embodiment of the present disclosure, the present disclosure also provides a computer program product. The computer program product includes: a computer program, and the computer program is stored in a readable storage medium. At least one processor of an electronic device can read the computer program from the readable storage medium, and the at least one processor executes the computer program to cause the electronic device to perform the solution provided in any of the foregoing embodiments.

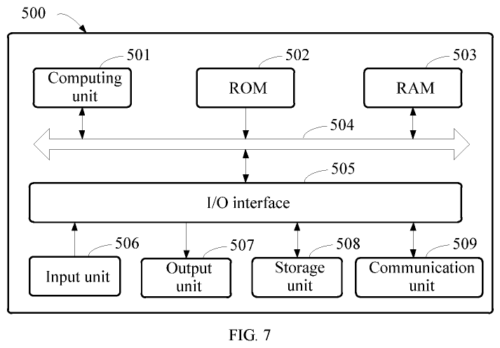

FIG. 7 shows a schematic block diagram of an example electronic device 500 that can be used to implement embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may also represent various forms of mobile apparatuses, such as a personal digital assistant, a cellular phone, a smartphone, a wearable device, and other similar computing apparatuses. The electronic device can also represent a vehicle with an automatic driving function, such as an intelligent vehicle. The above electronic device may also represent a server. Components, their connections and relationships, and their functions shown herein are merely examples, and are not intended to limit the implementation of the present disclosure described and/or claimed herein.

As shown in FIG. 7, the device 500 includes a computing unit 501, which may perform various appropriate actions and processing according to a computer program stored in a read-only memory (ROM) 502 or a computer program loaded from a storage unit 508 to a random access memory (RAM) 503. In the RAM 503, various programs and data required for operations of the device 500 may also be stored. The computing unit 501, the ROM 502 and the RAM 503 are connected to each other by a bus 504. An input/output (I/O) interface 505 is also connected to the bus 504.

A number of components in the device 500 are connected to the I/O interface 505, including: an input unit 506, for example, a keyboard, a mouse, etc.; an output unit 507, for example, various types of displays, speakers, etc.; the storage unit 508, for example, a disk, an optical disc, etc.; and a communication unit 509, for example, a network card, a modem, a wireless communication transceiver, etc. The communication unit 509 allows the device 500 to exchange information/data with other devices through a computer network such as the Internet and/or various telecommunication networks.

The computing unit 501 may be various types of general-purpose and/or special-purpose processing components with processing and computing capabilities. Some examples of the computing unit 501 include, but are not limited to, a central processing unit (CPU), a graphics processing unit (GPU), various dedicated artificial intelligence (AI) computing chips, various computing units for running machine learning model algorithms, a digital signal processor (DSP), and any appropriate processor, controller, microcontroller, etc. The computing unit 501 executes the multipath generation methods described in the above embodiments. For example, in some embodiments, the multipath generation method may be implemented as a computer software program, which is tangibly contained in a machine-readable medium, for example, the storage unit 508. In some embodiments, part or all of computer programs may be loaded into and/or installed on the device 500 via the ROM 502 and/or the communication unit 509. When the computer program is loaded into the RAM 503 and executed by the computing unit 501, one or more steps of the multipath generation method described above may be performed. Alternatively, in other embodiments, the computing unit 501 may be configured to perform the multipath generation method by means of any other appropriate means (for example, by means of firmware).

Various embodiments of the systems and the technologies described above herein may be implemented in a digital electronic circuit system, an integrated circuit system, a field programmable gate array (FPGA), an application-specific integrated circuit (ASIC), an application-specific standard product (ASSP), a system on chip (SOC), a complex programmable logic device (CPLD), computer hardware, firmware, software, and/or a combination thereof. These various embodiments may include: being implemented in one or more computer programs, where the one or more computer programs may be executed and/or interpreted on a programmable system including at least one programmable processor, and the programmable processor may be a dedicated or general-purpose programmable processor that may receive data and instructions from a storage system, at least one input apparatus and at least one output apparatus, and transmit data and instructions to the storage system, the at least one input apparatus and the at least one output apparatus.

Program codes used to implement the methods of the present disclosure may be written in any combination of one or more programming languages. These program codes may be provided to a processor or a controller of a general-purpose computer, a special-purpose computer, or other programmable data processing devices, so that when the program codes are executed by the processor or the controller, functions/operations specified in flowcharts and/or block diagrams are implemented. The program codes may be entirely executed on a machine, partly executed on the machine, and partly executed on the machine and partly executed on a remote machine as an independent software package, or entirely executed on a remote machine or a server.

In the context of the present disclosure, a machine-readable medium may be a tangible medium, which may contain or store a program for use by an instruction execution system, apparatus, or device or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination of the foregoing. More specific examples of the machine-readable storage medium would include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

In order to provide an interaction with a user, the systems and the technologies described herein may be implemented on a computer, the computer being equipped with: a display apparatus for displaying information to the user (for example, a CRT (cathode ray tube) or LCD (liquid crystal display) monitor); and a keyboard and a pointing apparatus (for example, a mouse or a trackball) through which the user may provide input to the computer. Other types of apparatuses may also be used to provide an interaction with the user; for example, a feedback provided to the user may be any form of sensory feedback (for example, visual feedback, auditory feedback, or tactile feedback); and input from the user may be received in any form (including an acoustic input, a voice input, or a tactile input).

The systems and the technologies described herein may be implemented in a computing system (for example, as a data server) that includes a back-end component, or a computing system (for example, an application server) that includes a middleware component, or a computing system (for example, a user computer with a graphical user interface or a web browser through which the user may interact with the embodiments of the systems and the technologies described herein) that includes a front-end component, or a computing system that includes any combination of the back-end component, the intermediate component or the front-end component. Components of the system may be connected to each other through digital data communication (for example, a communication network) of any form or medium. Examples of the communication network include: a local area network (LAN), a wide area network (WAN), and the Internet.

A computer system may include a client and a server. The client and the server are generally far away from each other and usually interact through a communication network. A relationship between the client and the server is generated by computer programs that run on corresponding computers and have a client-server relationship with each other. The server may be a cloud server, also known as a cloud computing server or a cloud host, which is a host product in a cloud computing service system, to solve defects of high management difficulty and weak business scalability existing in services of a traditional physical host and a virtual private server (Virtual Private Server, or VPS for short) service. The server may also be a server of a distributed system, or a server combined with a blockchain.

It should be understood that steps may be reordered, added or deleted for various forms of procedures shown above. For example, the steps recorded in the present disclosure may be performed in parallel, sequentially, or in a different order, as long as desired results of the technical solutions disclosed in the present disclosure can be realized, which is not limited herein.

The above specific embodiments do not constitute a limitation to the protection scope of the present disclosure. Those skilled in the art should understand that various modifications, combinations, sub-combinations and substitutions may be made according to design requirements and other factors. Any modification, equivalent replacement, improvement and so on made within the spirit and the principle of the present disclosure shall be included in the protection scope of the present disclosure.

What is claimed is:

1. A multipath generation method, comprising:
in response to a path generation request, generating M recommended paths from a starting node to a destination node, the starting node being a node that a path starting point in the path generation request is mapped to in a traffic topology network, and the destination node being a node that a path ending point in the path generation request is mapped to in the traffic topology network;
wherein the M recommended paths are generated through m path generation processes comprising: in an i-th path generation process, generating nᵢ recommended paths based on a constructed search tree, and for each recommended path of the nᵢ recommended paths, determining traffic costs of road segments of the recommended path in an (i+1)-th path generation process according to penalty factors, the traffic costs being associated with a recommendation priority of path; wherein m≥i≥1, M>nᵢ>1.

2. The method according to claim 1, wherein each recommended path of the nᵢ recommended paths comprises a plurality of road segments, and the plurality of road sections respectively correspond to a plurality of penalty factors;
determining the traffic costs of the road segments of the recommended path in the (i+1)-th path generation process according to the penalty factors comprises:
determining, according to a penalty factor corresponding to each road segment of the plurality of road segments, a traffic cost of the road segment in the (i+1)-th path generation process.

3. The method according to claim 2, wherein the method further comprises:
determining the penalty factors respectively corresponding to the plurality of road segments of the recommended path according to positions of the plurality of road segments of the recommended path in the recommended path.

4. The method according to claim 1, wherein generating the nᵢ recommended paths based on the constructed search tree comprises:
constructing a search tree from the starting node to the destination node, wherein the search tree comprises Nᵢ meeting points, Nᵢ≥nᵢ, and the Nᵢ meeting points are path nodes on Nᵢ paths from the starting node to the destination node respectively;
determining the nᵢ recommended paths according to traffic costs respectively corresponding to the Nᵢ paths.

5. The method according to claim 2, wherein generating the ni recommended paths based on the constructed search tree comprises:
constructing a search tree from the starting node to the destination node, wherein the search tree comprises Ni meeting points, Ni≥ni, and the Ni meeting points are path nodes on Ni paths from the starting node to the destination node respectively;
determining the ni recommended paths according to traffic costs respectively corresponding to the Ni paths.

6. The method according to claim 3, wherein generating the ni recommended paths based on the constructed search tree comprises:
constructing a search tree from the starting node to the destination node, wherein the search tree comprises Ni meeting points, Ni≥ni, and the Ni meeting points are path nodes on Ni paths from the starting node to the destination node respectively;
determining the ni recommended paths according to traffic costs respectively corresponding to the Ni paths.

7. The method according to claim 4, wherein constructing the search tree from the starting node to the destination node comprises:
constructing the search tree by starting from the starting node and the destination node respectively, and ending a search tree constructing process when the Nᵢ meeting points of the search tree are formed.

8. The method according to claim 4, wherein each path of the Nᵢ paths comprises a plurality of road segments;
determining the nᵢ recommended paths according to the traffic costs respectively corresponding to the Nᵢ paths comprises:
for each path of the Nᵢ paths, summing traffic costs respectively corresponding to the plurality of road segments of the path, to obtain a traffic cost of the path;
sorting the Nᵢ paths in ascending order of the traffic costs, and determining first nᵢ paths as the nᵢ recommended paths.

9. The method according to claim 1 wherein the method further comprises:
in response to a first trigger event, stopping executing the (i+1)-th path generation process; wherein,
the first trigger event comprises at least one of the following:
i is greater than or equal to a preset quantity of iterations;
execution time is greater than or equal to preset iteration time, wherein a start time of the execution time is a start time of a first path generation process, and an end time of the execution time is an end time of the i-th path generation process;
a sum of quantities of recommended paths generated by first i path generation processes is greater than or equal to a preset quantity of paths.

10. The method according to claim 2, wherein the method further comprises:
in response to a first trigger event, stopping executing the (i+1)-th path generation process; wherein,
the first trigger event comprises at least one of the following:
i is greater than or equal to a preset quantity of iterations;
execution time is greater than or equal to preset iteration time, wherein a start time of the execution time is a start time of a first path generation process, and an end time of the execution time is an end time of the i-th path generation process;
a sum of quantities of recommended paths generated by first i path generation processes is greater than or equal to a preset quantity of paths.

11. The method according to claim 1, wherein generating the M recommended paths from the starting node to the destination node comprises:
merging
$${\sum }_{1}^{m} {n}_{i}$$
recommended paths generated in the m path generation processes according to a merging parameter, to obtain the M recommended paths.

12. The method according to claim 2, wherein generating the M recommended paths from the starting node to the destination node comprises:
merging
$${\sum }_{1}^{m} {n}_{i}$$
recommended paths generated in the m path generation processes according to a merging parameter, to obtain the M recommended paths.

13. The method according to claim 3, wherein generating the M recommended paths from the starting node to the destination node comprises:
merging
$${\sum }_{1}^{m} {n}_{i}$$
recommended paths generated in the m path generation processes according to a merging parameter, to obtain the M recommended paths.

14. The method according to claim 11, wherein the method further comprises:
determining whether a target area is a road sparse area according to a first ratio, wherein the target area comprises the starting node and the destination node, and the first ratio is a ratio of a quantity of valid path generation processes to m;
correcting the merging parameter when the target area is the sparse road area.

15. The method according to claim 14, wherein the method further comprises:
if a recommended path with the highest recommendation priority among the nᵢ recommended paths is not a recommended path generated in first i−1 path generation processes, determining the i-th path generation process as a valid path generation process.

16. The method according to claim 1, wherein the method further comprises:
performing burr area identification on the M recommended paths, and correcting a burr area.

17. The method according to claim 2, wherein the method further comprises:
performing burr area identification on the M recommended paths, and correcting a burr area.

18. The method according to claim 3, wherein the method further comprises:
performing burr area identification on the M recommended paths, and correcting a burr area.

19. An electronic device comprising:
at least one processor; and
a memory communicatively connected with the at least one processor; wherein
the memory stores instructions executable by the at least one processor, and the instructions are executed by the at least one processor to enable the at least one processor to:
in response to a path generation request, generate M recommended paths from a starting node to a destination node, the starting node being a node that a path starting point in the path generation request is mapped to in a traffic topology network, and the destination node being a node that a path ending point in the path generation request is mapped to in the traffic topology network;
wherein the M recommended paths are generated through m path generation processes comprising: in an i-th path generation process, generating nᵢ recommended paths based on a constructed search tree, and for each recommended path of the nᵢ recommended paths, determining traffic costs of road segments of the recommended path in an (i+1)-th path generation process according to penalty factors, the traffic costs being associated with a recommendation priority of path; wherein m≥i≥1, M>nᵢ>1.

20. A non-transitory computer-readable storage medium having computer instructions stored thereon, wherein the computer instructions are used to cause a computer to execute the following steps:
in response to a path generation request, generate M recommended paths from a starting node to a destination node, the starting node being a node that a path starting point in the path generation request is mapped to in a traffic topology network, and the destination node being a node that a path ending point in the path generation request is mapped to in the traffic topology network;
wherein the M recommended paths are generated through m path generation processes comprising: in an i-th path generation process, generating nᵢ recommended paths based on a constructed search tree, and for each recommended path of the nᵢ recommended paths, determining traffic costs of road segments of the recommended path in an (i+1)-th path generation process according to penalty factors, the traffic costs being associated with a recommendation priority of path; wherein m≥i≥1, M>nᵢ>1.
